(19) United States
(12) Patent Application Publication
(10) Pub. No.: US 2022/0225800 A1
(43) Pub. Date: Jul. 21, 2022

(54) STORYBOOK STORAGE SYSTEM

(71) Applicant: CRISTINA E. DeFURIA, (US)

(72) Inventor: CRISTINA E. DeFURIA, Toms River, NJ (US)

(21) Appl. No.: 17/574,692

(22) Filed: Jan. 13, 2022

Related U.S. Application Data
(60) Provisional application No. 63/137,885, filed on Jan. 15, 2021.

(51) Int. Cl. A47G 9/10; B42D 3/12

(52) U.S. Cl. CPC A47G 9/1045; B42D 3/12

(57) ABSTRACT

A storybook storage system, in which a foldable pillow, shaped like a storybook or a wizard's hat, is constructed with two fabric sleeves that allow a child to insert the covers of a bedtime storybook into the sleeves thereby providing for secure storage of the storybook after bedtime reading.

### FIELD OF THE INVENTION

The field of the instant invention is books for reading to children.

### BACKGROUND

Repeated readings of the same storybook help children learn novel words, particularly for children ages 3 to 5 years old. This fact is documented in the literature. See, for example, the work of Margaret Merga, et al stating: “There's a reason your child wants to read the same book over and over again,” as quoted in the The Conversation, 1 Nov. 2018, https://theconversation.com/theres-a-reason-your-child-wants-to-read-the-same-book-over-and-over-again-105733. One of the most significant parts of a child's nighttime routine is the bedtime book. This story time begins with a parent reading to them and ultimately leads to the child beginning to read independently as well. A problem that arises has to do with the storing the nightly book. When the story is done often the child will either leave the book sprawled on their bed or it will fall behind the bed, onto the floor or, the child will have to get up to put it away, breaking the sleepy feeling they had just moments earlier. If a parent takes the book, the next night when it is time for the story it may be left downstairs or somewhere else that now the parent must go look for it, cutting into the time together.

Thus, often the book will fall behind the child's bed, the book itself may wind up in different parts of the home that parents then have to find it, and children may have to get out of bed after their story to put it away on a shelf; leading to the peaceful and tired feeling of slumber being interrupted abruptly. The instant invention solves all of these issues and more for children and families.

### SUMMARY OF THE INVENTION

During the early years of development, our brains begin to associate different things with pleasure and attachment. The instant invention provides children with a comforting and transitional object that directly relates to reading; holding safely their favorite bedtime stories. With this invention of a foldable pillow for storage of storybooks, they can begin to develop a comforting connection with reading books.

### BRIEF DESCRIPTION OF THE DRAWINGS

FIGS. 1 and 2 depict the preferred embodiment of the storybook storage system 100. FIG. 1 shows that the folded pillow 10 is shaped like a book itself. FIG. 2 shows that when you open the pillow there are two fabric folder sleeves 11 that allow for a child to insert the cover of their bedtime story front and back cover. When the child is done reading for the night, they simply leave the book in its place and close the pillow 10 by folding it.

FIGS. 3 and 4 are different views of one embodiment of an ornamental design for the system 100 of the instant invention, a wizard hat design pillow 20. This embodiment of the pillow 20 opens at the brim of the wizard hat and has fabric folder sleeves 21 for insertion of the storybook.

FIGS. 5 and 6 demonstrate embodiments with different ornamental designs of system 100. These embodiments of pillow 30 and pillow 40 hold true to the basic storybook storage system form and use the front pillow cover to add animal faces as in FIG. 5, crowns as in FIG. 6, or other designs children love.

### DETAILED DESCRIPTION OF THE INVENTION

The instant storage system 100 is based on is a pillow 10 that folds open from a pillow shape to provide two fabric folder sleeves 11 to support the bedtime storybook and store it for the night. Upon folding the storage system 100 back together, it is now a comfortable pillow 10 to sleep on or cuddle with. This system 100 is designed to serve the purpose of both a comfortable way for kids to read their nighttime stories as well as a place to store them. The instant invention can also be a pillow that the child keeps on his or her bed, takes to sleepovers, and can be used to cuddle up with or sleep on. The storage system 100 itself can take on any ornamental shape or design. What makes it special is the inside folder pockets 11 that allow for a book to be securely stored.

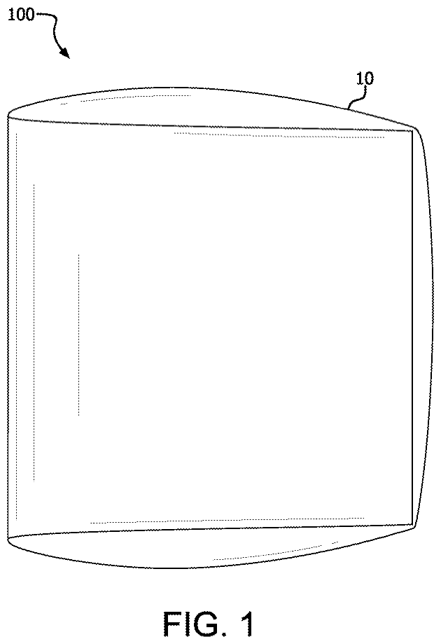

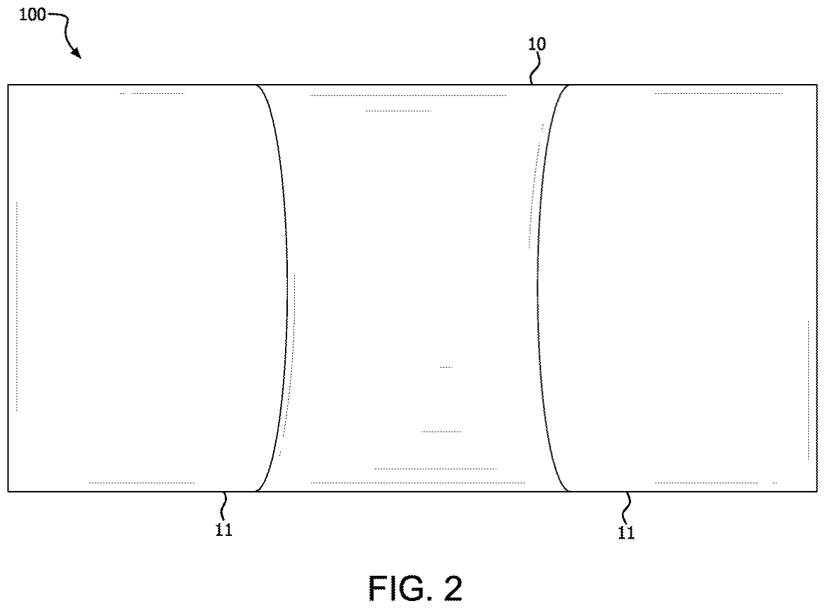

FIGS. 1 and 2 depict the most basic embodiment of the storybook storage system 100. FIG. 1 shows that the pillow 10 is shaped like a book itself. FIG. 2 shows that when you open the pillow there are two fabric folder sleeves 11 that allow for a child to insert the cover of their bedtime story front and back cover. When the child is done reading for the night, they simply leave the book in its place and close the pillow 10.

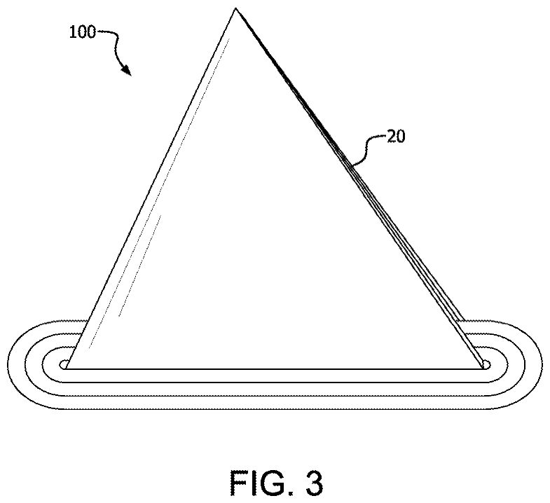

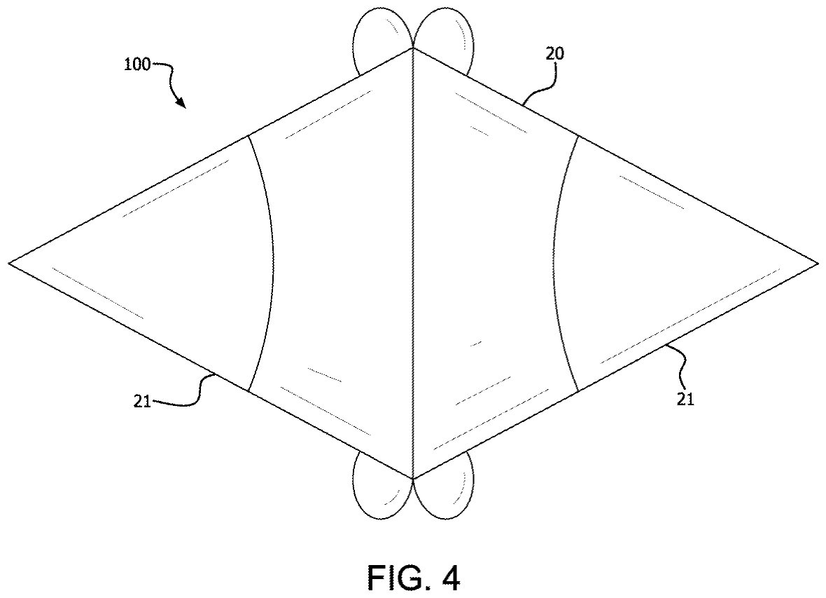

FIGS. 3 and 4 are different views of one embodiment of an ornamental design for the system 100 of the instant invention, a wizard hat design pillow 20. This embodiment of the pillow 20 opens at the brim of the wizard hat and has fabric folder sleeves 21 for insertion of the storybook.

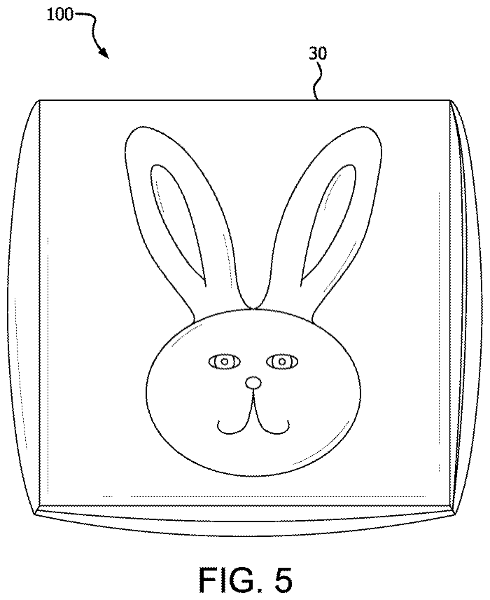

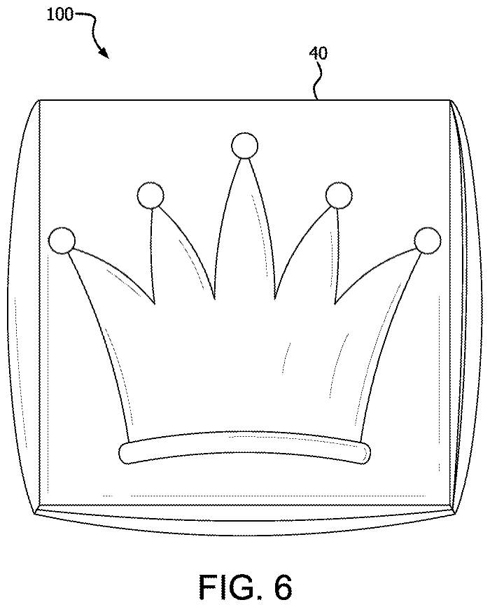

FIGS. 5 and 6 demonstrate embodiments of system 100 with different ornamental designs. These embodiments of pillow 30 and pillow 40 hold true to the basic storybook storage system 100 form and use the front pillow cover to add animal faces as in FIG. 5, crowns as in FIG. 6, or other designs children love.

1. A storage system for a book comprising a foldable pillow having at least two sleeves attached at the edges of one side of said pillow, wherein said sleeves are of a size that allows for the front cover of said book to be securely contained within said left sleeve and said back cover of said book to be securely contained within said right sleeve whereby said book is securely stored within said system in the case in which said right side of said pillow is folded over said left side of said pillow.

2. The storage system of claim 1 further comprising a design attached to one side of said pillow in the case in which said pillow is folded, said design selected from the group consisting of: a bunny face and a crown.

3. The storage system of claim 1 in which said pillow is constructed in the shape of a wizard's hat.
